(19) United States
(12) Patent Application Publication
(10) Pub. No.: US 2023/0189988 A1
(43) Pub. Date: Jun. 22, 2023

(54) ANTI-VIBRATION DEVICE FOR SOUND EQUIPMENT

(71) Applicant: B Lam Limited, Kwai Chung (HK)

(72) Inventor: Wai Ming LAM, Hong Kong (HK)

(21) Appl. No.: 18/153,848

(22) Filed: Jan. 12, 2023

Related U.S. Application Data
(63) Continuation-in-part of application No. 15/931,218, filed on May 13, 2020, now abandoned.
Application No. 15/931,218 is a continuation of application No. 15/835,051, filed on Dec. 7, 2017, now Pat. No. 10,667,606.

(30) Foreign Application Priority Data
Dec. 8, 2016 (CN) 201611127617.5

(51) Int. Cl. A47B 81/06; F16F 15/04; A47B 97/00

(52) U.S. Cl. CPC A47B 81/06; F16F 15/04; A47B 97/00

(57) ABSTRACT

An anti-vibration device for sound equipment having a stress frame with an adjustable shape to form a complimentary shape to the sound equipment so that vibration is optimized by setting the adjustable shape. The anti-vibration device can be used in a rack with other anti-vibration devices or between sound equipment and a support platform. The anti-vibration device may also be used on top of the sound equipment while supporting a variable weight.

### RELATED APPLICATIONS

This application is a Continuation-In-Part Application of U.S. application. Ser. No. 15/931,218 filed on May 13, 2020, which is a Continuation Application of U.S. application Ser. No. 15/835,051 filed Dec. 7, 2017, which itself claims priority to Chinese App. No. 201611127617.5 filed Dec. 8, 2016, the disclosures and teachings of which are incorporated herein by reference in their entirety for all purposes.

### TECHNICAL FIELD

The present disclosure relates to anti-vibration devices for sound equipment and sound equipment racks with one or more anti-vibration devices, and in particular, to anti-vibration devices for reducing the consonance and resonance of sound equipment and/or of a laminate plate supporting the sound equipment, wherein the devices may have an elastic stress frame.

### BACKGROUND

The case of sound equipment and the laminate plate supporting the sound equipment have similar characteristics in a musical instrument room when the sound equipment and the laminate plate supporting the sound equipment are played, struck or subjected to sound waves, vibrations, and the like. Different levels of consonance and resonance are generated under different conditions. Under the influence of the consonance and resonance, the sound equipment and the laminate plate supporting the sound equipment will no longer maintain their original static, quiet and stable normal working state. As a result, not only does the sound equipment and laminate plate(s) generate consonance and resonance, the respective sound equipment can output a distorted sound.

Conventionally, feet and pads for supporting the sound equipment are made of a hard material. Since the contact area between the foundations and pads and the sound equipment is large, the hard feet and pads cannot prevent the consonance and resonance from occurring and influencing the sound equipment. When vibration comes, the sound equipment will generate resonance and consonance and output a greatly distorted sound.

### SUMMARY

The present disclosure provides for an anti-vibration device which is used for reducing consonance and resonance.

In one embodiment, the subject technology is directed to a sound equipment assembly having a first anti-vibration device and second anti-vibration device. The first anti-vibration device includes: a first elastic stress frame having a first linear strip shape with two support portions at each end thereof for contact with the sound equipment to suspend the linear strip shape above the sound equipment, wherein the first linear strip shape is a first stress deformation portion; a second elastic stress frame forming a holding space configured to receive the sound equipment, the second elastic stress frame having a second linear strip shape and two support bolts, each support bolt having an inward hook portion on a distal end thereof, wherein the first linear strip shape is a second stress deformation portion; and a bolt having a tip threads through the second linear strip shape so that tightening pushes the tip against the first linear strip shape to deform the first and second elastic stress frames to produce a long-term stable internal stress therein and, thereby, reduce vibration of the sound equipment. The second anti-vibration device includes a stress frame having an adjustable shape to form a complimentary shape to the sound equipment so that vibration is optimized by setting the adjustable shape. The sound equipment assembly may also include a sound equipment rack coupled to the first and second anti-vibration devices and the sound equipment.

Another embodiment of the subject technology is directed to an anti-vibration device for sound equipment having a stress frame having an adjustable shape to form a complimentary shape to the sound equipment so that vibration is optimized by setting the adjustable shape. The stress frame can be circular or any other shape. Preferably, the anti-vibration device has a plurality of straight adjustable stress arms selectively rotatably connected to the stress frame. The plurality of straight adjustable stress arms may three stress arms secured by fasteners to a first side of the stress frame and three stress arms secured by fasteners to a second side of the stress frame. Each stress arm can benefit from a standoff on a distal end thereof. A wedge standoff forms a contact line and a funnel shaped standoff forms a point contact.

The anti-vibration device can be under the sound equipment. Or, one or more weights can be suspended by the stress frame to deform the stress frame to set a stable internal stress. A plurality of different weights provide the ability to select one of the weights for suspension to minimize consonance and resonance.

In another embodiment, the stress frame includes a plurality of stress frame sections interconnected with standoff sections and upright sections. Each section may be attached together by fasteners that are tightened to hold a desired configuration. A second anti-vibration device can support a portion of the stress frame.

Still another embodiment of the subject technology is an anti-vibration device for sound equipment having a first elastic stress frame having a first linear strip shape with two support portions at each end thereof for contact with the sound equipment to suspend the linear strip shape above the sound equipment, wherein the first linear strip shape is a first stress deformation portion. A second elastic stress frame forms a holding space configured to receive the sound equipment, the second elastic stress frame having a second linear strip shape and two support bolts, each support bolt having an inward hook portion on a distal end thereof, wherein the first linear strip shape is a second stress deformation portion. A bolt has a tip and threads through the second linear strip shape so that tightening pushes the tip against the first linear strip shape to deform the first and second elastic stress frames to produce a long-term stable internal stress therein and, thereby, reduce vibration of the sound equipment. By selectively turning the bolt during operation of the sound equipment, the vibration is minimized to set a position of the bolt. Preferably, the first and second linear strip shapes form a right angle.

In one embodiment, the device has an elastic stress frame, and a sound equipment rack with an anti-vibration device. By applying the elastic stress frame to the case of sound equipment and/or the laminate plate supporting the sound equipment in advance, which is similar to applying a suitable stress at the center of the cavity, the stable internal stress thereof is utilized to allow the case of the sound equipment and/or the laminate plate supporting the sound equipment to maintain their original position and state as much as possible, so that the sound equipment and/or the laminate plate supporting the sound equipment cannot generate consonance and resonance, reducing noise and/or the degree of distortion of the sound equipment.

The elastic stress frame produces a long-term stable internal stress in the following two ways. The first one is that the sound equipment is applied to the elastic stress frame, and produces, with its own weight, downward pressure on the elastic stress frame, so that the elastic stress frame is deformed and produces a long-term stable internal stress. The second one is that the elastic stress frame is mechanically locked, by means of screw fastening, onto the outside of the sound equipment to apply threaded fastening pressure on the sound equipment, so that the elastic stress frame is deformed and produces a long-term stable internal stress. This results in high requirements for the material that makes the elastic stress frame. Firstly, the material used to make the elastic stress frame should have sufficient strength to support the weight of the sound equipment itself. Secondly, the material used to make the elastic stress frame should have proper elasticity to produce certain elastic deformation when applied to the sound equipment.

The present disclosure provides for an anti-vibration device for sound equipment, the anti-vibration device comprising an elastic stress frame, the elastic stress frame having a stress deformation portion and a plurality of support portions, the support portions protruding toward one side with respect to the stress deformation portion. The elastic stress frame may have a solid triangular shape, a Y-shaped star shape, a hollow triangular shape or a four-legged bridge shape. Preferably, the support portions are located at radially outer end portions that form the shape of the elastic stress frame, the stress deformation portion being formed by connection portions between the support portions. The elastic stress frame may have a linear strip shape, the support portions being located at both ends that form the linear strip shape of the elastic stress frame.

In another embodiment, the support portions have, on a lower end thereof, contact lines for support, the contact lines being inclined or perpendicular with respect to the extending direction of the linear strip shape of the elastic stress frame.

Further, the elastic stress frame can have an arcuate shape, two ends of the arcuate shape of the elastic stress frame form the support portions, and the ends of the support portions have inwardly extending hook portions, the stress deformation portion and the inwardly extending hook portions of the support portions defining there between a holding space for holding the sound equipment. In another embodiment, the hook portion has a protrusion portion extending toward the stress deformation portion. The stress deformation portion has a protrusion portion thereon, the extending direction of the protrusion portion on the stress deformation portion being opposite to the extending direction of the support portions. The material of the elastic stress frame may be one selected from the group consisting of polymethylmethacrylate, polyacrylic acid, polyacrylate, polycarbonate, polystyrene, PE, PP, PET, PBT, ABS and combinations thereof.

The present disclosure further provides for an anti-vibration device for sound equipment. The anti-vibration device is a combined structure of a plurality of elastic stress frames which at least comprise a first elastic stress frame and a second elastic stress frame. The first and second elastic stress frames each have a stress deformation portion and support portions. The stress deformation portions of the first elastic stress frame are connected to the second elastic stress frame. The stress deformation portions of the first elastic stress frame may be located on the side where the support portions of the second elastic stress frame are located, with the extending direction of the support portions of the first elastic stress frame coinciding with the extending direction of the support portions of the second elastic stress frame. In another embodiment, the stress deformation portion of the first elastic stress frame is connected to the stress deformation portion of the second elastic stress frame. The first elastic stress frame can have at least two support portions distributed along a circumferential direction. The ends of support portions of the second elastic stress frame have inwardly extending hook portions, the support portions of the first elastic stress frame and the inwardly extending hook portions on the ends of the support portions of the second elastic stress frame defining there between a holding space for holding the sound equipment. Preferably, the stress deformation portion of the first elastic stress frame is connected to the end of the support portions of the second elastic stress frame away from the stress deformation portion of the second elastic stress frame, and a support surface for supporting the sound equipment is formed on the stress deformation portion of the second elastic stress frame.

The first elastic stress frame preferably has a solid triangular shape, a Y-shaped star shape, a hollow triangular shape or a four-legged bridge shape. The first elastic stress frame can have a linear strip shape, and the support portions of the first elastic stress frame are located at two ends that form the linear strip shape of the first elastic stress frame. Preferably, the support portions of the first elastic stress frame have, on a lower end thereof, contact lines for support, the contact lines being inclined or perpendicular with respect to the extending direction of the linear strip shape of the first elastic stress frame.

The present disclosure further provides for an anti-vibration device for sound equipment, the anti-vibration device is a combined structure of a plurality of elastic stress frames which at least comprise a first elastic stress frame and a second elastic stress frame, the first and second elastic stress frames each having a stress deformation portion and support portions, the support portions of the first elastic stress frame and the support portions of the second elastic stress frame protruding away from each other in opposite directions, the support portions on the second elastic stress frame and the support portions on the first elastic stress frame being arranged in an alternate manner along a circumferential direction.

Additionally, the first elastic stress frame has a ring shape, the number of the support portions of the first elastic stress frame is at least three, the at least three support portions of the first elastic stress frame being equidistantly distributed along the circumferential direction, and the stress deformation portion of the first elastic stress frame is formed by the arc-shaped ring segments between the support portions of the first elastic stress frame.

Additionally, the second elastic stress frame is located below the first elastic stress frame, the second elastic stress frame has a ring shape, the number of the support portions of the second elastic stress frame is at least three, the at least three support portions of the second elastic stress frame being equidistantly distributed along a circumferential direction, and the stress deformation portion of the second elastic stress frame is formed by the arc-shaped ring segments between the support portions of the second elastic stress frame.

Additionally, outer protrusions which have a width greater than the width of the ring and extend outward radially are provided at the positions where the stress deformation portion of the first elastic stress frame and the support portions of the first elastic stress frame are connected, and the support potions of the first elastic stress frame are provided on the outer protrusions.

Additionally, inner protrusions which have a width greater than the width of the ring and extend inward radially are provided at the positions where the stress deformation portion of the second elastic stress frame and the support portions of the second elastic stress frame are connected, and the support potions of the second elastic stress frame are provided on the inner protrusions.

Additionally, an intermediate position between two adjacent support portions on the stress deformation portion of the second elastic stress frame has an outwardly protruding shape corresponding to the outer protrusions on the stress deformation portion of the first elastic stress frame.

Additionally, an intermediate position between two adjacent support portions on the stress deformation portion of the first elastic stress frame has an inwardly protruding shape corresponding to the inner protrusions on the stress deformation portion of the second elastic stress frame.

Additionally, the first elastic stress frame has a Y-shaped star shape or a hollow triangular shape, the second elastic stress frame has a Y-shaped star shape or a hollow triangular shape.

Additionally, the materials of the first elastic stress frame and the second elastic stress frame may be one or a combination of at least two selected from polymethylmethacrylate, polyacrylic acid, polyacrylate, polycarbonate, polystyrene, PE, PP, PET, PBT and ABS.

The present disclosure further provides for a sound equipment rack with an anti-vibration device, the sound equipment rack comprising a rack body and an anti-vibration device, as described above, provided on the rack body.

The present disclosure further provides for a sound equipment rack, the rack body comprises a first upright column, a second upright column, a third upright column and a fourth upright column, the sound equipment rack comprising a first, second and third anti-vibration devices, the first and second anti-vibration devices being respectively the anti-vibration device comprising the elastic stress frame as described above and being respectively supported on the first upright column and the second upright column by means of cantilever beams, the third anti-vibration device being the anti-vibration device having a combined structure of a plurality of elastic stress frames as described above, the two support portions of the second elastic stress frame of the third anti-vibration device being respectively supported on the third upright column and the fourth upright column in a cantilevered manner, the first elastic stress frame of the third anti-vibration device being provided on the middle upper side of the stress deformation portion of the second elastic stress frame, the stress deformation portions of the elastic stress frames of the first and second anti-vibration devices and the stress deformation portion of the first elastic stress frame of the third anti-vibration device collectively forming a support surface for supporting the sound equipment.

Another embodiment of the subject technology is directed to an anti-vibration device for sound equipment, the anti-vibration device comprising: a first elastic stress frame having a first linear strip shape with two support portions at each end thereof for contact with the sound equipment to suspend the linear strip shape above the sound equipment, wherein the first linear strip shape is a first stress deformation portion; a second elastic stress frame forming a holding space configured to receive the sound equipment, the second elastic stress frame having a second linear strip shape and two support bolts, each support bolt having an inward hook portion on a distal end thereof, wherein: the first linear strip shape is a second stress deformation portion; and the first and second linear strip shapes form a right angle; and a bolt connecting the first and second linear strip shapes so that tightening the bolt deforms the first and second elastic stress frames to produce a long-term stable internal stress therein and, thereby, reduce vibration of the sound equipment.

Still another embodiment of the subject technology is directed to an anti-vibration device for sound equipment, the anti-vibration device comprising: a first elastic stress frame having a first linear strip with two support portions, wherein each support portion extends from opposite ends of the first linear strip in a same direction for contact with the sound equipment to suspend the linear strip above the sound equipment, wherein the first linear strip is a first stress deformation portion; a second elastic stress frame forming a holding space configured to substantially surround the sound equipment, the second elastic stress frame having a second linear strip and two support portions, each support portion extends from opposite ends of the second linear strip in a same direction, each support portion of the second linear strip having a respective inwardly extending portion on a distal end thereof, wherein: the second linear strip is a second stress deformation portion; and the first and second linear strips form a right angle; and a bolt connecting the first and second linear strips so that tightening the bolt is configured to apply a fastening pressure on to the sound equipment from different directions and deforms the first and second elastic stress frames and, thereby, reduces vibration of the sound equipment.

Through the above-mentioned arrangements, long-term stable internal stresses can be formed at all the interconnection points between the sound equipment, the elastic stress frame and the laminate plate for supporting the sound equipment due to the weight of the sound equipment itself and the return force of the elastic stress frame. Compared with the sound waves and resonance transmitted by the loudspeaker, these stresses have a stress strength far greater than the energy of the sound waves and resonance, so that most of the resonance cannot intrude into the sound equipment, the elastic stress frame and the laminate plate for supporting the sound equipment, whereby the output of the sound equipment is not affected by the external sound waves and resonance. At the time, the sound equipment can work stably without being influenced by sound waves and resonance, so as to achieve its own due performance, naturally reducing the distortion rate of outputted sound.

### BRIEF DESCRIPTION OF THE DRAWINGS

The accompanying drawings, which form a part of the disclosure, are used to provide a further understanding of the present disclosure.

FIG. 1 shows a perspective view of a first embodiment of an anti-vibration device for sound equipment.

FIG. 2 shows a perspective view of a variant of the shape of the first embodiment.

FIGS. 3A-J show top views of various variants of the shape of the first embodiment.

FIG. 4 shows a perspective view of a second structural variant of the first embodiment.

FIG. 5 shows a bottom perspective view of a third structural variant of the first embodiment.

FIG. 6 shows a top perspective view of a third structural variant of the first embodiment.

FIG. 7 shows a perspective view of a fourth structural variant of the first embodiment.

FIG. 8A shows a perspective view of a second embodiment of an anti-vibration device in use on sound equipment.

FIG. 8B shows an exploded view of the anti-vibration device of FIG. 8A.

FIG. 9 shows a perspective view of a variant of the shape of a second embodiment.

FIG. 10 shows a perspective view of a second structural variant of the second embodiment in use.

FIG. 11 shows a perspective view of a third embodiment of an anti-vibration device for sound equipment.

FIG. 12 shows a top view of a variant of the shape of the third embodiment.

FIG. 13 shows a perspective view of a sound equipment rack with the anti-vibration device.

FIG. 14 is a perspective view of the sound equipment rack with the anti-vibration device in use.

FIG. 15 shows a perspective view of another anti-vibration device for sound equipment.

FIG. 16 shows a perspective view of a third embodiment of an anti-vibration device for sound equipment.

FIG. 17 shows a perspective view of a third embodiment of an anti-vibration device for sound equipment.

FIG. 18 shows a perspective view of an adjustable anti-vibration device in use upon sound equipment.

FIG. 19 shows a perspective view of the adjustable anti-vibration device of FIG. 18.

FIG. 20 shows a perspective view of another adjustable anti-vibration device in use upon sound equipment.

FIG. 21 shows a perspective view of the adjustable anti-vibration device of FIG. 20.

FIG. 22 shows a perspective view of another adjustable anti-vibration device for sound equipment in isolation.

FIG. 23 shows a perspective view of the adjustable anti-vibration device of FIG. 22.

### DETAILED DESCRIPTION OF THE EMBODIMENTS

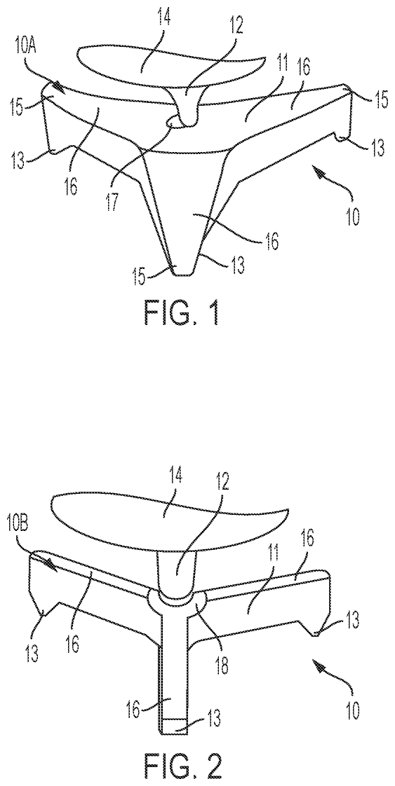

It should be noted that the embodiments disclosed herein and the features in the embodiments may be combined and/or swapped with each other in any combination. Aspects of the subject technology will be described in detail below with reference to the accompanying drawings and in combination with the embodiments. FIG. 1 is a perspective view of an anti-vibration device 10 for sound equipment 14. In FIG. 1, the anti-vibration device 10 for sound equipment 14 comprises an elastic stress frame 10A having a stress deformation portion 11 and three support portions 13 that protrude away from the stress deformation portion 11 and sound equipment 14. In this embodiment, the elastic stress frame 10A has a solid somewhat triangular shape with support portions 13 in contact with a support surface (not shown) at the radial outer end portions 15 of each corner thereof. Connection portions or arms 16 extending radially to the support portions 13 form the stress deformation portion 11.

The elastic stress frame 10A is provided between a foot 12 of the sound equipment 14 and the support surface for supporting the sound equipment 14 from below. The weight of the sound equipment 14 is pressed against the stress deformation portion 11 of the elastic stress frame 10A via the sound equipment foot 12, such that the stress deformation portion 11 is elastically deformed and produces a long-term stable internal stress. When the three support portions 13 come into contact with the support surface, the stress deformation portion 11 as a whole is suspended. Preferably, a central cupped hollow 17 effectively captures the foot 12.

In addition, the contact points between the support portions 13 and the support surface is three points equally spaced along a circle. The three point contacts between the three support portions 13 and the support surface enable the elastic stress frame 10A to be stable. The material for manufacturing the elastic stress frame 10A has sufficient strength to meet the requirements of supporting the weight of the sound equipment 14 and has appropriate elasticity so that when the sound equipment 14 set on the elastic stress frame 10A, the stress deformation portion 11 of the elastic stress frame 10A will be elastically deformed to a certain degree. The material for manufacturing the elastic stress frame 10A is may be acrylic (also known as acrylic or plexiglass) such as polymethylmethacrylate (PMMA). Of course, other materials with similar properties, such as materials selected from the group consisting of polyacrylic acid, polyacrylate, polycarbonate, polystyrene, PE, PP, PET, PBT and ABS, can also be used.

FIG. 2 is a perspective view of a variant of the shape of the first embodiment. Similar reference numbers are used when possible and the following description is directed primarily to the difference. In FIG. 2, the elastic stress frame 10B is a three-pointed star shape having three strip-shaped arms 16 that intersect at a center 18. The arms 16 are equidistantly distributed along a circumferential direction and extend outwardly with depending support portions 13 protruding from the radial outer end portions 15. The connecting strip-shaped arms 16 form the stress deformation portion 11. Compared with the solid triangular shape of FIG. 1, the elastic stress frame 10B in the three-pointed star shape has a lighter weight, saves material and manufacturing cost, and is suitable for supporting sound equipment having a relatively lighter weight.

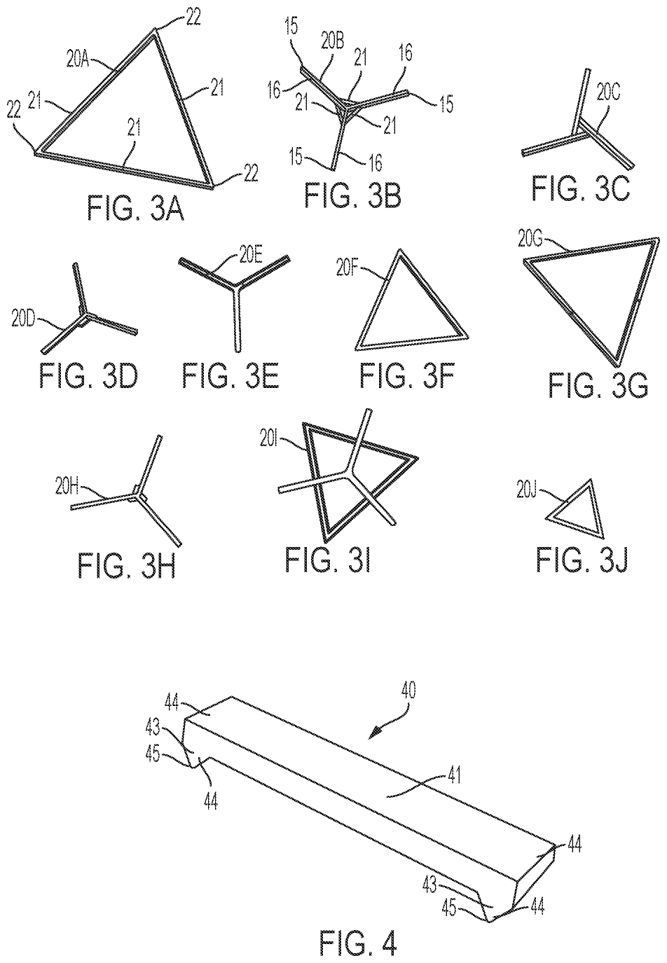

FIGS. 3A-J are top views of various shapes for elastic stress frames in accordance with the subject technology. In FIG. 3A, the elastic stress frame 20A comprises a hollow triangular shape, the three sides 21 of the hollow triangle shape form the stress deformation portion of the elastic stress frame 20A. The triangular apexes 22 at the connection of the three sides, i.e. the radial outer end portions of the hollow triangle form the support portions (not shown) protruding toward one side. The frame 20A suitably forms a plane by three sides to support the sound equipment, and stabilizes the sound equipment.

In FIG. 3B, there is another Y-shaped star shaped stress frame 20B with a central reinforcing structure 21. The reinforcing structure 21 is preferably reinforcing ribs mounted between two adjacent arms 16 close to centrally located. The support portions (not shown) depend from radial outer end portions 15 distal from the reinforcing structure 21. The arms 16 and the reinforcing structure 21 form the stress deformation portion. By providing the reinforcing structure 21 centrally, the disadvantage of insufficient strength caused by the thinner strip-shaped arms 16 is overcome. Thus, the frame 20B is suitable for supporting sound equipment having a moderate weight. FIGS. 3C-3J include similar variation frames 20C-20J having various benefits and advantages as would be appreciated by those of ordinary skill based upon review of the subject disclosure.

FIG. 4 is another embodiment of an elastic stress frame 40. In FIG. 4, the elastic stress frame 40 has a linear strip shape. The elastic stress frame 40 comprises a stress deformation portion 41 and two support portions 43. The two support portions 43 protrude from the stress deformation portion 41. The support portions 43 are located at both ends 44 of the stress deformation portion 41 for contact with the support surface. When the support portions 43 are in contact with the support surface, the stress deformation portion 41 as a whole is suspended. In addition, the support portions 43 have, at a lower end thereof, contact lines 45 for support, and the contact lines 45 are inclined or perpendicular with respect to the length of the linear strip shape of the elastic stress frame 40. The line contact between the two support portions 43 and the support surface enables the elastic stress frame 40 to be more stabilized. In another embodiment, the stress frame 40 includes a hollow to capture the respective sound equipment foot and a stress frame 40 is coupled to each foot. The hollow of the stress frame may be any complimentary shape to accommodate sound equipment feet of any shape. It is envisioned that the stress frame 40 may also have an upstanding collar to capture the sound equipment foot.

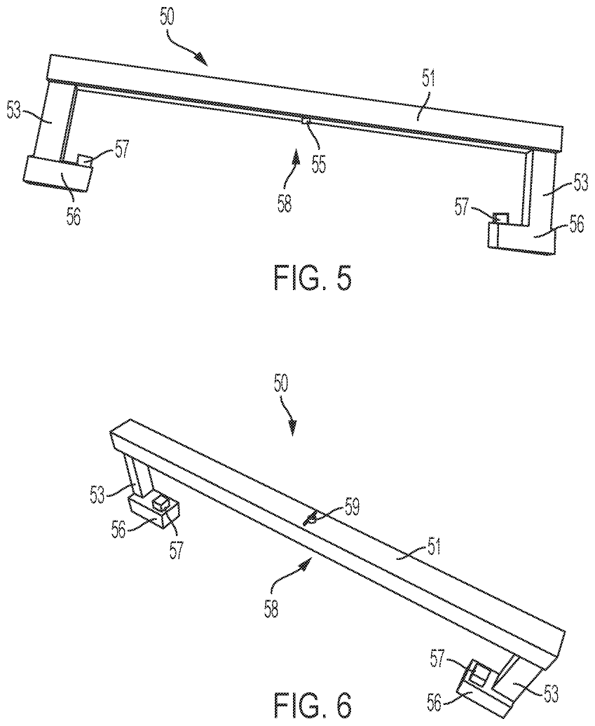

FIG. 5 and FIG. 6 are bottom and top perspective views of another stress frame system 50, respectively. In FIGS. 5 and 6, the elastic stress frame 50 has an elongated rod which is the stress deformation portion 51 with support portions 53 that come into contact with the sound equipment (not shown). Each support portion 53 has an inwardly extending hook portion 56. A space 58 for holding the sound equipment is defined between the stress deformation portion 51 of the elastic stress frame 50 and the inwardly extending hook portions 56 of the support portions 53. In use, the elastic stress frame 50 is sleeved around the sound equipment, and the elastic stress frame 50 is fastened around the sound equipment by tightening a bolt 55 through a central threaded hole 59 of the stress deformation portion 51, thereby applying tightening pressure onto the sound equipment in a circumferential direction, so that the stress deformation portion 51 is deformed, resulting in a long-term and stable internal stress. By adjusting the position of the bolt 55, the deformation and, in turn, the optimization of the reduction of consonance and resonance and distortion can be made. For example, the user may simply listen while adjusting the bolt 55 for best performance. In addition, a protrusion portion 57 extending toward the stress deformation portion 51 may also be provided on the hook portion 56. The protrusion portions 57 effectively reduce the contact area between the elastic stress frame 50 and the sound equipment at the support portions 53, thereby further enhancing the effects of vibration prevention and consonance and resonance reduction.

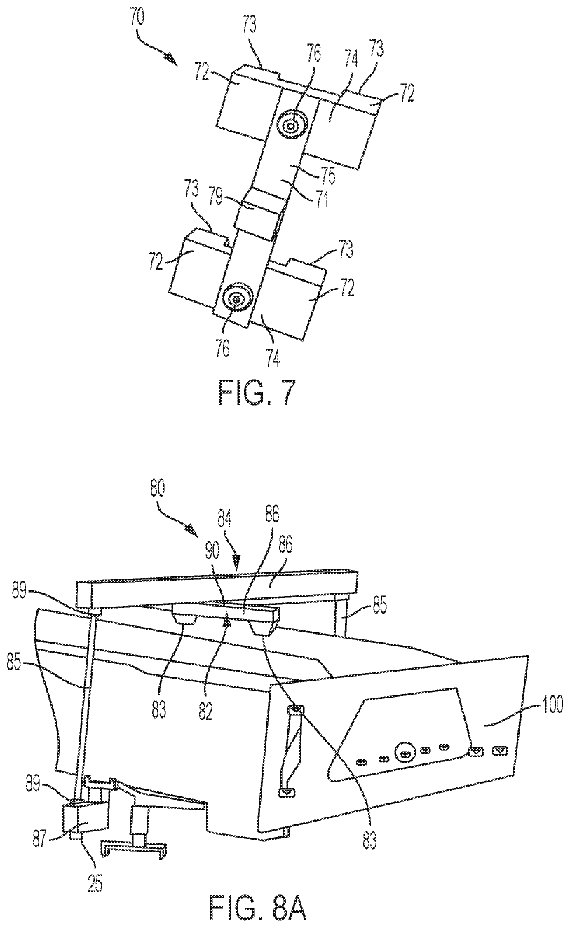

FIG. 7 is a perspective view of still another elastic stress frame 70 having two opposing legs 74 with a central bar 75 extending between the legs 74 to form a stress deformation portion 71 with four protruding support portions 73. The four support portions 73 are located on four feet 72 of the four-legged bridge shape. The bridge shape between the four support portions 73 forms the stress deformation portion 71. Each leg 74 is coupled to the central bar 75 with a fastener 76.

Normally, the elastic stress frame 70 is provided at a lower portion of the sound equipment for supporting the sound equipment from below. When the support portions 73 come in contact with the support surface, the stress deformation portion 71 as a whole is suspended, and the weight of the sound equipment itself is pressed against the stress deformation portion 71 so that the stress deformation portion 71 is deformed and produces a long-term stable internal stress. In addition, an optional upstanding block 79 may be provided on the stress deformation portion 71. The upstanding block 79 effectively reduces the contact area between the elastic stress frame 70 and the sound equipment on the stress deformable portion 71, thereby further enhancing the effects of vibration prevention and consonance and resonance reduction.

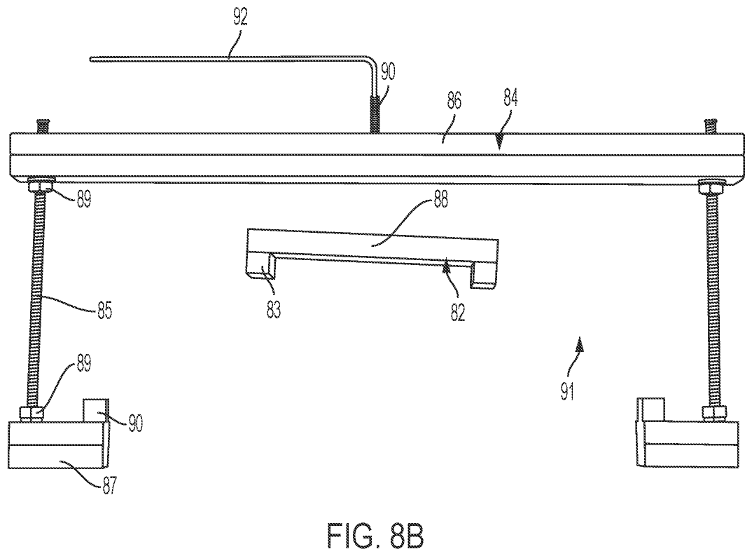

Referring now to FIGS. 8A and 8B, various views of an anti-vibration device 80 for use with sound equipment 100 are shown. The anti-vibration device 80 is a combination of two elastic stress frames 82, 84. The lower elastic stress frame 82 has a linear strip 88 with two contact feet 83 that are in contact with the sound equipment. The linear strip shape of the lower elastic stress frame 82 spans between the two contact feet 83 to create a stress deformation portion. When the two contact feet 83 come into contact with the sound equipment 100, the linear strip 88 is suspended. Preferably, the contact feet 83 have opposing sides that come to a contact line at lower ends thereof (not shown in the Figures) for supporting the sound equipment 100, and the contact lines are inclined or perpendicular with respect to the extending direction of the linear strip 88. The two contact lines between the contact feet 83 and the sound equipment 100 enable the first elastic stress frame 80 to be more stable. The hook portions 87 also have similar contact feet 89.

The upper elastic stress frame 84 forms a holding space 91 that extends around the sound equipment 100. The elastic stress frame 84 has two threaded support rails 85. A stress deformation linear strip 86 extends between the two support rails 85. The two support rails 85 each have a distal inwardly extending hook portion 87. Nut assemblies 89 help adjustably lock the rails 85 to the strip 86 and hook portions 87. The lower elastic stress frame 82 is coupled to the upper elastic stress frame 84 largely by pressure. A headless set screw passes 90 a threaded hole (not explicitly shown) in the upper elastic stress frame 84. Preferably, the set screw 90 is captured in a hollow in the lower elastic stress frame 82 so that once pressure occurs between the frames 82, 84, the lower frame 84 is fixed in place. The set screw 90 is selectively threaded to a desired depth using a tool 92 such as a hex wrench.

In use, the sound equipment 100 is within the holding space 91 and the frames 82, 84 are preferably perpendicular to each other but not necessarily so. Initially, the set screw 90 can be partially extending, say approximately 50% of outward travel, to assemble the device 80 on the sound equipment 100. The set screw 90 can also be initially set to a minimum or maximum of travel depending upon ease of assembly. By adjusting the length of the rails 85 between the hook portions 87 and the upper frame 84, the fastening or compressive force is generated there between upon the sound equipment 100. This compressive force against the periphery of the sound equipment 100 comes from different directions to selectively set and create a good general hold. To optimize the compressive force, the set screw 90 may then be utilized to increase or decrease the distance between the frames 82, 84. As a result, the final internal stress that deforms one or both of the frames 82, 84 can be finely adjusted. For example, the device 80 can be deployed and the sound equipment activated. During activation, the set screw 90 can be adjusted to minimize the consonance and resonance using a sound meter, the user's hearing, and the like. Once minimized, the frames 82, 84 are deformed to produce a long-term stable internal stress. Over time, if the device 80 needs further adjustment, the set screw 90 and even the setting of the rails 85 can be used to retune the device 80 for optimum performance. In view of the above, it is shown that the subject technology affords a unique ability to easily and quickly adjust performance of the device 80.

Preferably, the frames 82, 84 are made from comparable materials so that each is elastic and deformation is comparable. Although the first elastic stress frame 82 and the second elastic stress frame 84 may use the same kind of material, different kinds of materials may be used. For example, the materials of the first elastic stress frame 82 and the second elastic stress frame 84 may be acrylic (also referred to as plexiglass), the chemical composition of which is polymethylmethacrylate (PMMA). Of course, other materials with similar properties, such as one or a combination of at least two selected from polyacrylic acid, polyacrylate, polycarbonate, polystyrene, PE, PP, PET, PBT and ABS, can also be used.

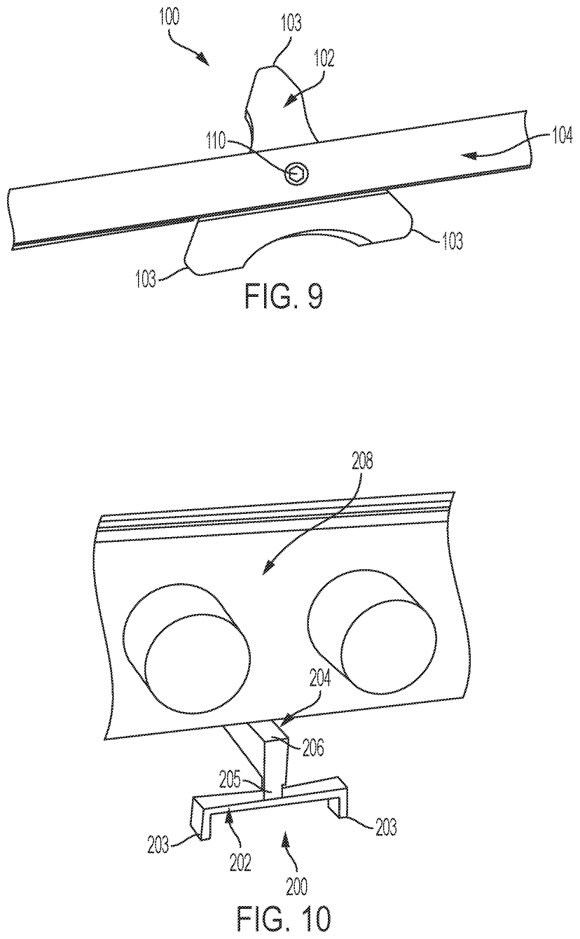

FIG. 9 is a partially enlarged perspective view of a device 100 similar to the device 80 of FIG. 8. The primary difference is the configuration of the lower elastic stress frame 102. The lower elastic stress frame 102 has a solid triangular shape with three outer support portions 103 in contact with the sound equipment. When the three support portions 103 come into contact with the sound equipment, the lower elastic stress frame 102 is suspended. The contact surface between the three support portions 103 and the sound equipment is a spherical surface, and the contacts thereof are point contacts. Thus, the elastic stress frame 102 is very stable. In one embodiment, the lower elastic stress frame 102 is coupled to the upper elastic stress frame 104 by a connection bolt 110 at a central point. The connection bolt 110 may insert through a throughbore of the upper elastic frame 104 and thread into a hole of the lower elastic stress frame 102 or be captured in a hollow to also set an optimal pressure as described above with respect to FIG. 8. The lower elastic stress frame 102 may also have any shape such as a Y-shaped star shape, a hollow triangular shape or a four-legged bridge shape.

FIG. 10 is a perspective view of another anti-vibration device 200 for sound equipment 208. The anti-vibration device 200 includes two lower elastic stress frames 202 and an upper elastic stress frame 204. It is noted that only one lower elastic stress frame 202 is shown. Each lower elastic stress frame 202 has a linear strip shape with two depending support portions 203. The linear strip shape between the two support portions 203 is the stress deformation portion. When the two support portions 203 are in contact with the support surface, the stress deformation portion as a whole is suspended. The support portions 203 have contact lines in contact with the support surface for support, and the contact lines are inclined or perpendicular with respect to the extending direction of the linear strip shape of the first elastic stress frame 202. The two contact lines between the support portions 203 and the support surface enable the lower elastic stress frame 202 to be more stabilized. The upper elastic stress frame 204 also has a linear strip shape, and is provided under the sound equipment 208. The upper elastic stress frame 204 of the linear strip shape has support portions 205 (only one support portion 205 shown) at both ends, and a stress deformation portion is formed between the two support portions 205.

The lower elastic stress frames 202 are connected to the upper elastic stress frame 204 by connecting the stress deformation portions thereof to the support portions 205 of the upper elastic stress frame 204. The extending direction of the linear strip shape of the lower elastic stress frames 202 form certain angles, for example, right angles, with the extending direction of the linear strip shape of the upper elastic stress frame 204. A support surface 206 for supporting the sound equipment 208 is formed on the stress deformation portion of the upper elastic stress frame 204. In use, the sound equipment 208 is put on the stress deformation portion of the upper elastic stress frame 204 to press against the combined structure of the plurality of elastic stress frames 202, 204. Due to the weight of the sound equipment 208, pressure deforms the lower elastic stress frames 202 and the upper elastic stress frame 204 to produce a long-term stable internal stress. Here, the frames 202, 204 may use the same kind of material, and may also use different kinds of materials. In addition, the lower and upper stress frames may also have other shapes, such as a Y-shaped star shape, a hollow triangular shape or a four-legged bridge shape.

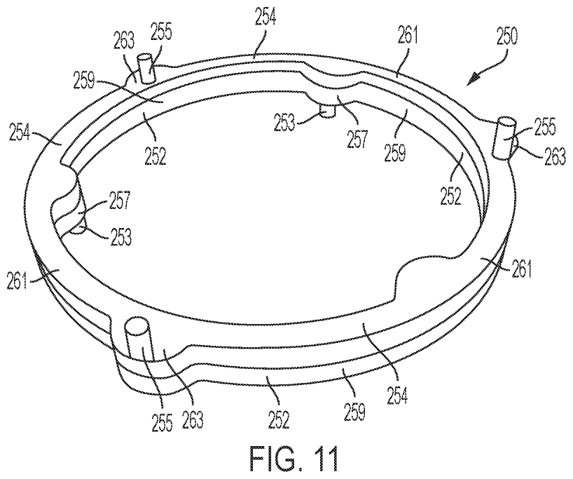

FIG. 11 is a bottom perspective view of another anti-vibration device 250 for sound equipment. The anti-vibration device 250 is a combined structure of a plurality of elastic stress frames 252, 254. Although two stress frames 252, 254 are shown together, more may be similarly arranged. The first elastic stress frame 252 and the second elastic stress frame 254 both have the same ring shape. The first elastic stress frame 252 has three support portions 253 in contact with the sound equipment. The three support portions 253 are equidistantly distributed on the ring shape, each portion 253 under a corresponding inner protrusion 257. The three arc-shaped ring segments 259 between the three support portions 253 form the stress deformation portions.

The second elastic stress frame 254 has three support portions 255 in contact with the support surface equidistantly distributed. The support portions 255 extend from radially outward protrusions 263. The three arc-shaped ring segments 261 between the three support portions 255 are the stress deformation portions. The support portions 255 and the support portions 253 are arranged in an alternate manner in the circumferential direction. As can be seen, the support portions 253 of the first elastic stress frame 20D and the support portions 255 of the second elastic stress frame 30D protrude toward different directions away from each other. That is, the stress deformation portions 259 of the first elastic stress frame 252 are located on the opposite side of the support portions 255 of the second elastic stress frame 254, and the stress deformation portions 261 of the second elastic stress frame 254 are located on the opposite side of the support portions 253 of the first elastic stress frame 252. When the three support portions 253 of the first elastic stress frame 252 are in contact with the sound equipment and the three support portions 255 of the second elastic stress frame 254 are in contact with the support surface, the respective stress deformation portions 259, 261 as a whole are suspended. In use, the first elastic stress frame 252 and the second elastic stress frame 254 are combined together and placed under the sound equipment between the sound equipment and the support surface for supporting the sound equipment from below, such that the stress deformation portions 259, 261 are deformed and produce a long-term stable internal stress.

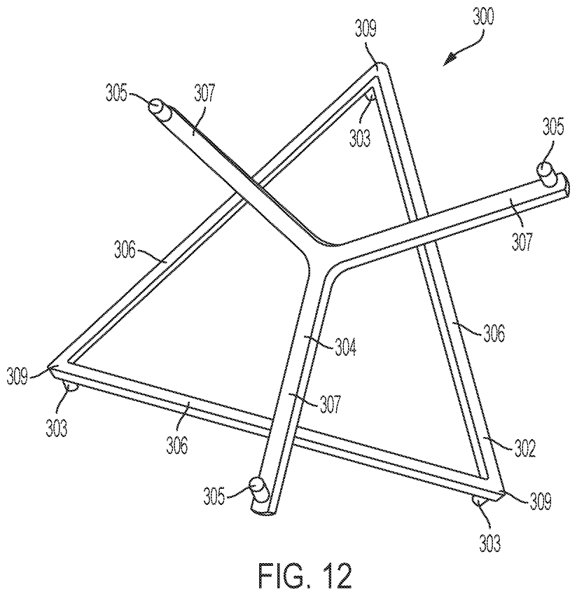

FIG. 12 is a top view of still another anti-vibration device 300 having an upper elastic stress frame 304 of a Y-shaped star shape, and a lower elastic stress frame 302 of a hollow triangular shape. Three support portions 305 contact with the sound equipment and are provided on the radial outer end portion of each branch 307 of the Y-shaped star shape of the first elastic stress frame 20E. The Y-shaped connection portion between the three support portions 305 is the stress deformation portion. Three support portions 303 are in contact with the support surface and provided on the corners 309 the lower elastic stress frame 302. The triangular side portions 306 between the three support portions 303 are the stress deformation portions.

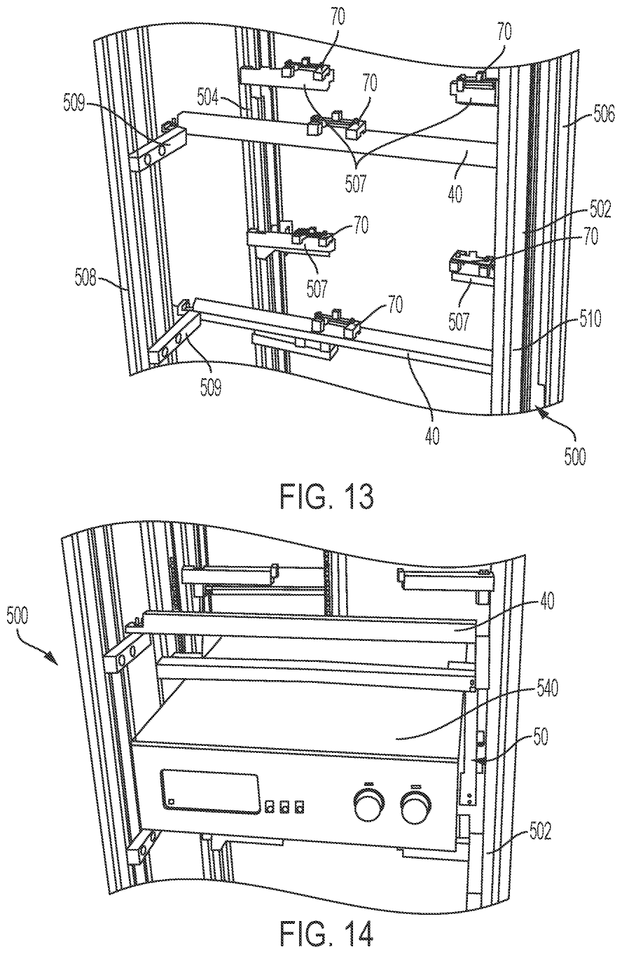

FIG. 13 is a perspective view of a sound equipment rack 500 with a plurality of anti-vibration devices 70, respectively. The sound equipment rack 500 has a rack body 502 provided with two sets of three anti-vibration devices 40, 70 as described above with respect to FIGS. 4 and 7. The rack body 502 comprises a first upright column 504, a second upright column 506, a third upright column 508 and a fourth upright column 510. Each set of three anti-vibration devices 70 is arranged in a planar triangle. Several of the anti-vibration devices 70 are supported by cantilever beams 507 extending from the respective upright column 504, 506.

Two anti-vibration devices 70 are supported by another anti-vibration device 40. These two anti-vibration devices 40 are in turn supported by cantilever beams 509 extending from the third upright column 508 and the fourth upright column 510, respectively. The anti-vibration devices 40, 70 collectively form a support surface for supporting the sound equipment. Of course, the above-mentioned other devices and shapes may also be adopted, for example, a linear strip shape, a Y-shaped star shape or a hollow triangular shape.

As there are various kinds of sound equipment, the shape, size and weight characteristics vary greatly. The anti-vibration devices of the subject technology can be flexibly designed and manufactured in different forms so as to match each to meet the usage requirements of different types of sound equipment, and finally achieve the ideal effects of reducing consonance and resonance reduction and distortion reduction. For example, see FIG. 14 that shows sound equipment 540 held in a rack 500 using anti-vibration devices 40, 50.

In addition, not only the anti-vibration device for sound equipment can be provided outside the sound equipment, but also enough space can be reserved therein in the design and manufacturing of the sound equipment and a laminate plate for supporting the sound equipment. The anti-vibration device can be hidden between the sound equipment and the laminate plate for supporting the sound equipment, so that the sound equipment and the laminate plate for supporting the sound equipment appear more beautiful and are more convenient to use.

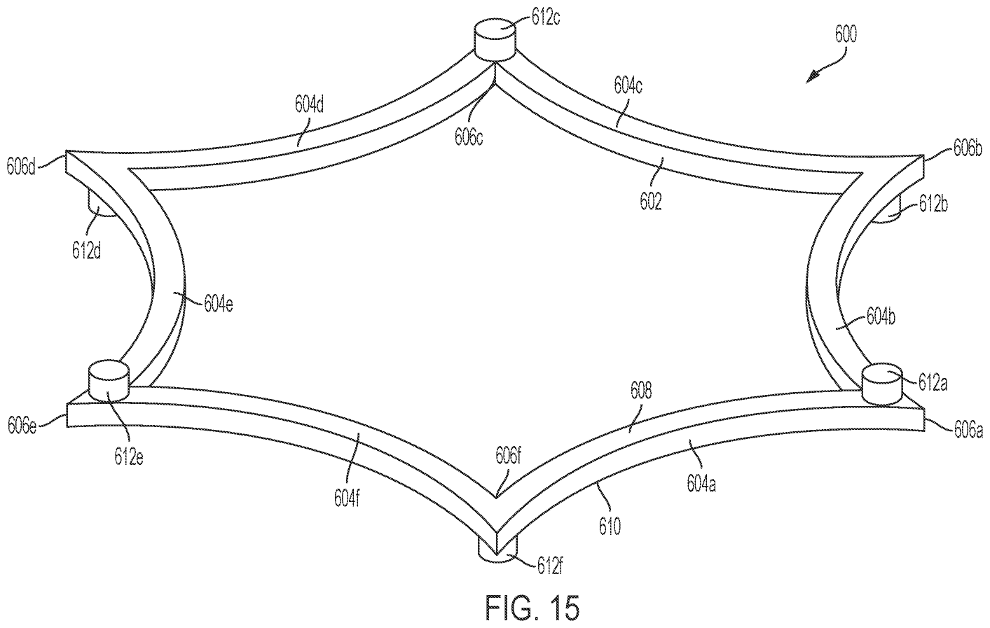

FIG. 15 shows a perspective view of a hexagonal anti-vibration device 600 for sound equipment. The anti-vibration device 600 is designed to be placed under the sound equipment and provide stable support while reducing the consonance, resonance and distortion. The anti-vibration device 600 has a stress frame 602 made of six arcuate sections 604a-f connected at six points 606a-f. The stress frame 602 has an upper side 608 with an opposing lower side 610. Six tubular standoffs 612a-f are arranged on the points 606a-f alternating between the upper side 608 and the lower side 610 so that each side has three contact points. Although the standoffs 612a-f are shown as the same button-shape, the standoffs may vary in shape and size. For example, the standoffs may be cubes, balls, polyhedrons, pyramids, wedges and like shapes. In another embodiment, the standoffs are cubes of the upper side and wedges with a triangular cross-section on the lower side. As a result, the anti-vibration device 600 is stable but only makes three line contact points with the supporting surface. The anti-vibration device 600 can be integrally formed or made of a plurality of pieces bonded together with any number of standoffs.

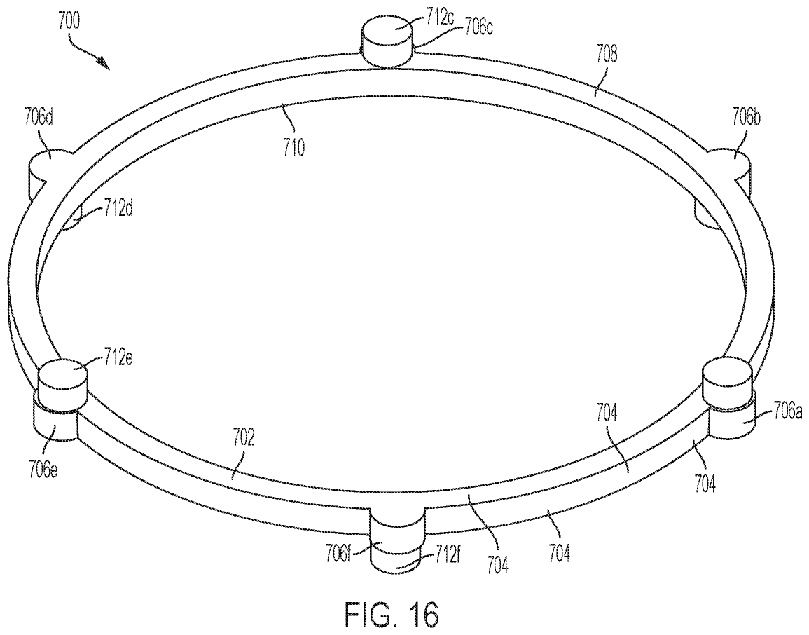

FIG. 16 shows a perspective view of a circular anti-vibration device 700 for sound equipment. The anti-vibration device 700 is similar to the anti-vibration device 600 so the following discussion uses like reference numerals where possible and is directed to the differences. The primary difference is that the anti-vibration device 700 has a circular stress frame 702 made up of a plurality of straight sections 704. The stress frame 702 has six radially outward protrusions 706a-f, each protrusion 606 supporting a button standoff 712a-f.

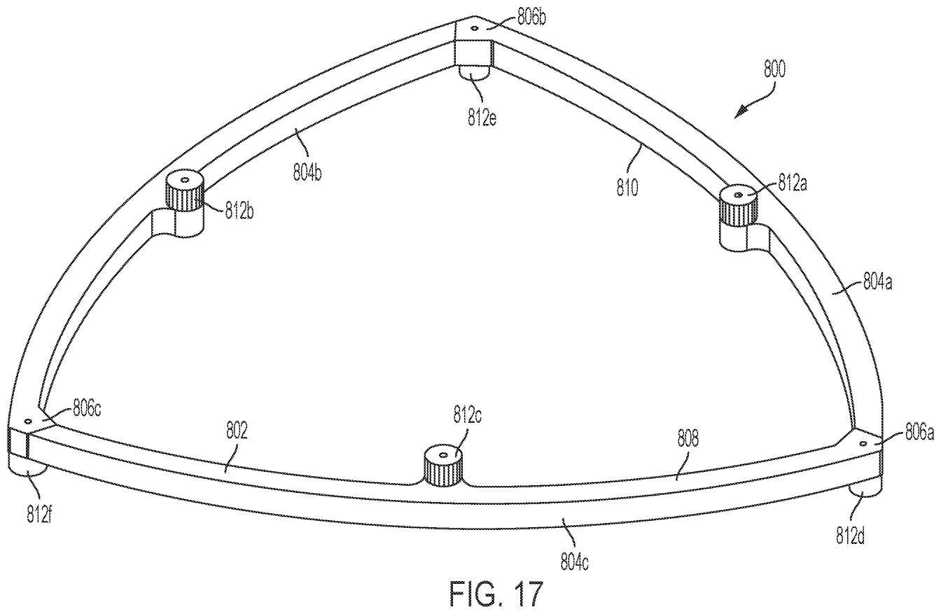

FIG. 17 shows a triangular anti-vibration device 800 for sound equipment. The anti-vibration device 800 is similar to the anti-vibration devices 600, 700 so the following discussion uses like reference numerals where possible and is directed to the differences. The primary difference is that the anti-vibration device 800 has a triangular stress frame 802 made up of three sections 804a-c connected at points 806a-c. The stress frame 802 has three radially outward protrusions 806a-c, each protrusion 806a-c supporting a standoff 812a-c on the upper side 808. Each point 806a-c also has a depending standoff 812d-f on the lower side 810.

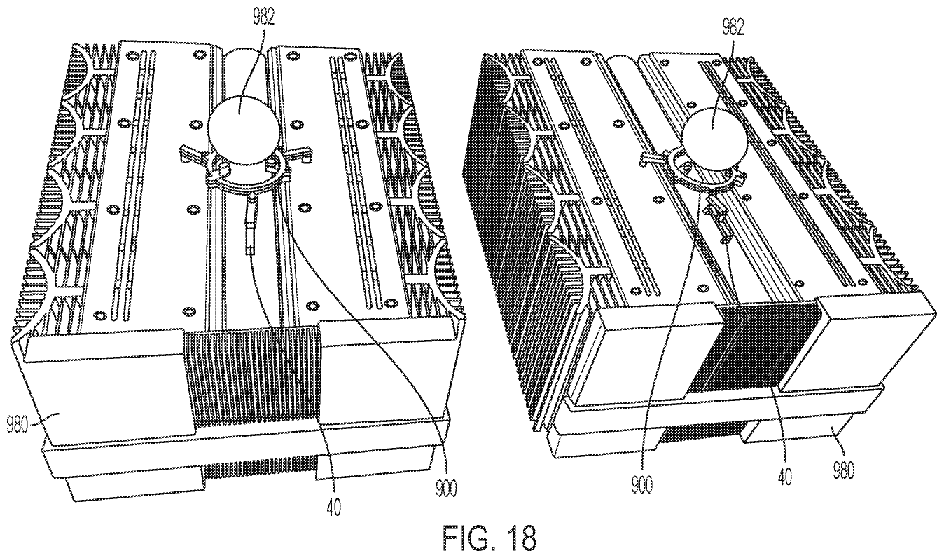

FIG. 18 shows a perspective view of an adjustable anti-vibration device 900 in use upon sound equipment 980. The anti-vibration device 900 is utilized on top of the sound equipment 980 to apply a downward pressure to reduce the consonance, resonance and distortion. The anti-vibration device 900 is supported by a different anti-vibration device 40 (discussed above) as needed to form a stable base to support a heavy sphere 982. As a result, the anti-vibration device 900 and the anti-vibration device 40 are deformed and apply downward force. The force can be modified and/or optimized by selection of variously weighted spheres. Of course, other shapes rather than spheres can be used for a load such as a cube, a bar, a bowl and the like.

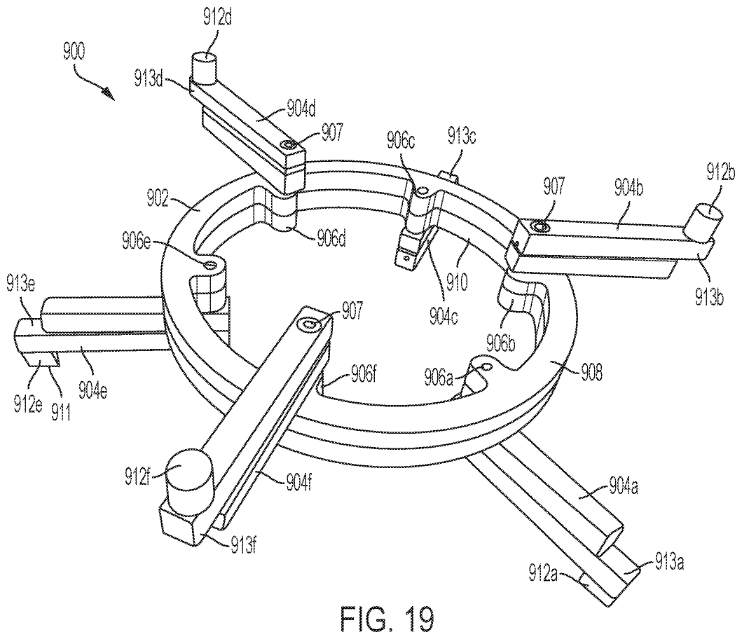

FIG. 19 shows a perspective view of the adjustable anti-vibration device 900 in isolation. The anti-vibration device 900 has a circular stress frame 902 with six straight adjustable stress arms 904a-f connected at six radially inward protrusions 906a-f by fasteners 907 (only three fasteners 907 of six shown). The stress frame 902 has a first side 908 with an opposing second side 910. Three stress arms 904b,d,f are arranged on the first side 908 and three stress arms 904a,c,e are arranged on the second side 910. Each stress arm 904a-f has a standoff 912a-f on a distal end 913a-f. As a result, each side 908, 910 has three contact points. The standoffs 912a,c,e are wedges with a triangular cross-section and the standoffs 912b,d,f are button-shaped. Thus, the wedge creates a line contact point 911. The stress arms 904a-f are shown as having two connected bars but a single bar or more may be utilized. By loosening the fasteners 907, each stress arm 904a-f can be rotated to a desired position to provide stability. For example, the stress arms 904a,c,e are rotated inward to support the sphere 982 as shown in FIG. 18 while the other stress arms 904b,d,f are rotated outward to land on the sound equipment 980 and other anti-vibration device 40 as needed.

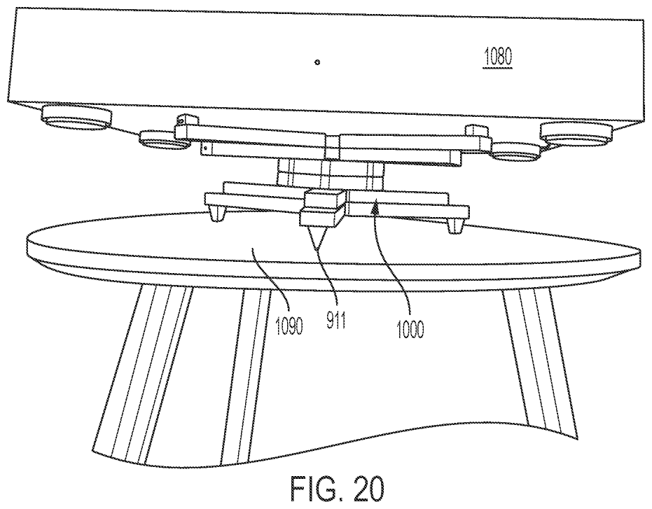

FIG. 20 shows a perspective view of an adjustable anti-vibration device 1000 in use upon sound equipment 1080. The anti-vibration device 1000 is utilized under the sound equipment 1080 on top of a support platform 1090, which is typically a laminar floor and/or the like. The sound equipment 1080 applies a downward pressure to deform the adjustable anti-vibration device 1000. The anti-vibration device 1000 reduces the consonance, resonance and distortion.

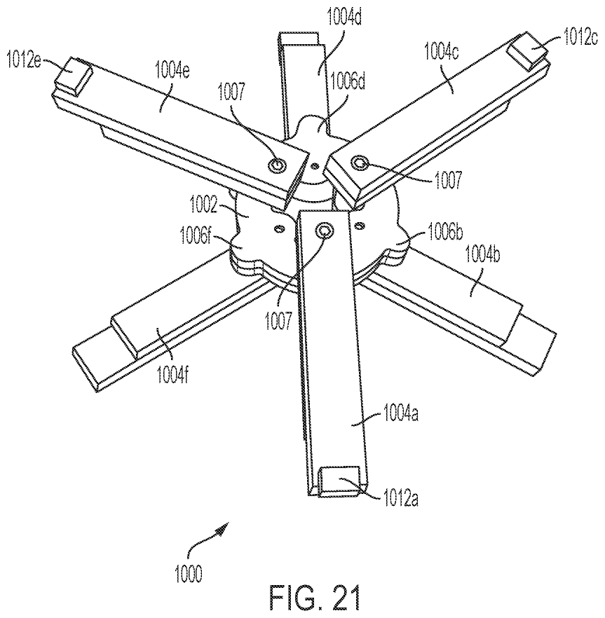

FIG. 21 shows a perspective view of the adjustable anti-vibration device 1000 in isolation. The anti-vibration device 1000 is very similar to the anti-vibration device 900 so that the following description uses like reference numerals when possible. The primary difference is that the circular stress frame 1002 is relatively smaller with relatively longer adjustable stress arms 1004a-f.

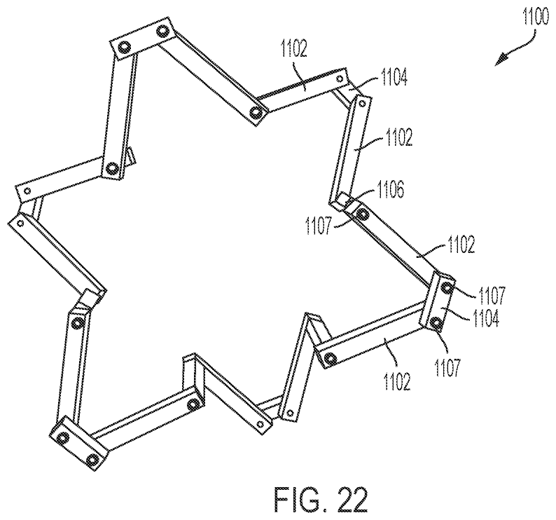

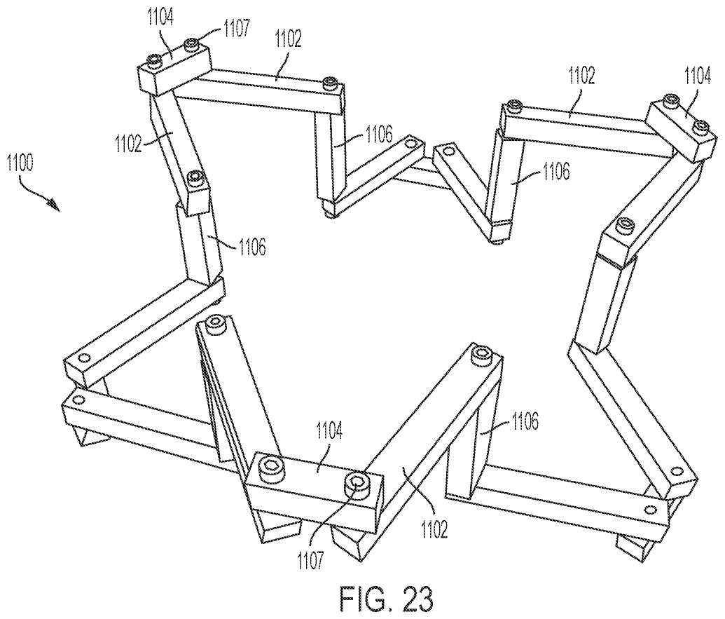

FIGS. 22 and 23 show perspective views of another adjustable anti-vibration device 1100 for sound equipment in isolation. The anti-vibration device 1100 has a plurality of stress frame sections 1102 interconnected with standoff sections 1104 and upright sections 1106. Each section 1102, 1104, 1106 is attached by fasteners 1107 in threaded holes (not explicitly shown). As interconnected, the anti-vibration device 1100 may be set into a plurality of different configurations by manually shaping the anti-vibration device 1100 to a desired configuration, then tightening the fasteners 1107. The fasteners 1107 on the standoff sections 1104 can perform double duty by acting as the point contacts with the support platform, sound equipment, load weight etc. In another embodiment, the standoff sections 1104 include surface, line contact and/or point contact standoffs as described herein.

Various other components may be included and called upon for providing for aspects of the teachings herein. For example, additional materials, combinations of materials and/or omission of materials may be used to provide for added embodiments that are within the scope of the teachings herein.

A variety of modifications of the teachings herein may be realized. Generally, modifications may be designed according to the needs of a user, designer, manufacturer or other similarly interested party. The modifications may be intended to meet a particular standard of performance considered important by that party.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” and forms thereof are intended to be inclusive such that there may be additional elements other than the listed elements. As used herein, the term “exemplary” is not intended to imply a superlative example. Rather, “exemplary” refers to an embodiment that is one of many possible embodiments.

While the subject technology has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A sound equipment assembly comprising:
a first anti-vibration device including: a first elastic stress frame having a first linear strip shape with two support portions at each end thereof for contact with the sound equipment to suspend the linear strip shape above the sound equipment, wherein the first linear strip shape is a first stress deformation portion; a second elastic stress frame forming a holding space configured to receive the sound equipment, the second elastic stress frame having a second linear strip shape and two support bolts, each support bolt having an inward hook portion on a distal end thereof, wherein the first linear strip shape is a second stress deformation portion; and a bolt having a tip threads through the second linear strip shape so that tightening pushes the tip against the first linear strip shape to deform the first and second elastic stress frames to produce a long-term stable internal stress therein and, thereby, reduce vibration of the sound equipment; and
a second anti-vibration device including a stress frame having an adjustable shape to form a complimentary shape to the sound equipment so that vibration is optimized by setting the adjustable shape.

2. A sound equipment assembly as recited in claim 1, further comprising a sound equipment rack coupled to the first and second anti-vibration devices and the sound equipment.

3. An anti-vibration device for sound equipment, the anti-vibration device comprising:
a stress frame having an adjustable shape to form a complimentary shape to the sound equipment so that vibration is optimized by setting the adjustable shape.

4. An anti-vibration device as recited in claim 3, wherein the stress frame is circular.

5. An anti-vibration device as recited in claim 4, further comprising a plurality of straight adjustable stress arms selectively rotatably connected to the stress frame.

6. An anti-vibration device as recited in claim 5, wherein the plurality of straight adjustable stress arms is three stress arms secured by fasteners to a first side of the stress frame and three stress arms secured by fasteners to a second side of the stress frame.

7. An anti-vibration device as recited in claim 6, wherein each stress arm has a standoff on a distal end thereof and at least half of the standoffs are wedges.

8. An anti-vibration device as recited in claim 3, further comprising at least one weight configured to be suspended by the stress frame to deform the stress frame to set a stable internal stress.

9. An anti-vibration device as recited in claim 8, wherein the at least one weight is a plurality of different weights, one of the weights being selected for suspension based on minimizing consonance and resonance.

10. An anti-vibration device as recited in claim 3, wherein the stress frame includes a plurality of stress frame sections interconnected with standoff sections and upright sections.

11. An anti-vibration device as recited in claim 10, wherein each section is attached together by fasteners that are tightened to hold a desired configuration.

12. An anti-vibration device as recited in claim 3, further comprising a second anti-vibration device for supporting a portion of the stress frame.

13. An anti-vibration device for sound equipment, the anti-vibration device comprising:
a first elastic stress frame having a first linear strip shape with two support portions at each end thereof for contact with the sound equipment to suspend the linear strip shape above the sound equipment, wherein the first linear strip shape is a first stress deformation portion;
a second elastic stress frame forming a holding space configured to receive the sound equipment, the second elastic stress frame having a second linear strip shape and two support bolts, each support bolt having an inward hook portion on a distal end thereof, wherein the first linear strip shape is a second stress deformation portion; and
a bolt having a tip and threaded through the second linear strip shape so that tightening the bolt pushes the tip against the first linear strip shape to deform the first and second elastic stress frames to produce a long-term stable internal stress therein and, thereby, reduce vibration of the sound equipment.

14. An anti-vibration device as recited in claim 13, wherein by selectively turning the bolt during operation of the sound equipment, the vibration is minimized to set a position of the bolt.

15. An anti-vibration device as recited in claim 13, wherein the first and second linear strip shapes form a right angle.

16. An anti-vibration device for sound equipment comprising:
a stress frame including a first side and a second side opposing the first side;
a plurality of standoffs alternately arranged on the first side and the second side so that each side has at least one contact point, wherein the anti-vibration device is configured to be placed under the sound equipment and provide stable support while reducing the consonance, resonance and distortion.

17. An anti-vibration device as recited in claim 16, wherein the stress frame is hexagonal and includes six arcuate sections connected at six points and the standoffs are arranged on the points alternating between the upper side and the lower side so that each side has three contact points.

18. An anti-vibration device as recited in claim 16, wherein the standoffs are selected from the shape consisting of: button-shaped; cubes; balls; polyhedrons; pyramids; wedges; and combinations thereof.

19. An anti-vibration device as recited in claim 16, wherein the stress frame is circular and includes six radially outward protrusions, each protrusion supporting a button standoff.

20. An anti-vibration device as recited in claim 16, wherein the stress frame is triangular, each corner of the stress frame having a standoff on the first side, and the stress frame having three protrusions, each protrusion being intermediate the corners and supporting one of the standoffs on the second side.
